(19) United States
(12) Patent Application Publication
(10) Pub. No.: US 2011/0168208 A1
(43) Pub. Date: Jul. 14, 2011

(54) METHOD OF CLEANING OIL CONTAMINATED SOLID PARTICULATES

(75) Inventors: Dale Stanley Steichen, Danbury, CT (US); Hua Yu, Scarsdale, NY (US)

(73) Assignee: Akzo Nobel N.V., Amhem (NL)

(21) Appl. No.: 13/063,592

(22) PCT Filed: Sep. 9, 2009
(86) PCT No.: PCT/EP2009/061665

§ 371 Date: Mar. 11, 2011

Related U.S. Application Data
(60) Provisional application No. 61/096,460, filed on Sep. 12, 2008.

(30) Foreign Application Priority Data
Dec. 1, 2008 (EP) 08170330.8

(51) Int. Cl. B08B 7/04; C11D 3/20; C11D 3/60

(52) U.S. Cl. 134/18; 510/365

(57) ABSTRACT

The present invention generally relates to a process for the cleaning oil contaminants from solid particulates. The invention also relates to a process and a surfactant composition for cleaning oil contaminated solids, such as cuttings, from oil and gas well drilling operations, and the separation and recovery of the oil from solid particulates.

### FIELD OF INVENTION

The present invention relates to a process for the cleaning oil contaminants from solid particulates. More specifically, the invention relates to a process and a surfactant composition for cleaning oil contaminated solids, such as cuttings, from oil and gas well drilling operations, and the separation and recovery of the oil from solid particulates.

### BACKGROUND OF THE INVENTION

The modern drilling process utilizes drilling fluids which are pumped down the drill string, through the drill bit, and back to the surface in the annular space between the drill string and the well in order to carry and remove the cuttings from the well. Technically complex well designs often require high performance oil based drilling fluids which can provide some distinct advantages, such as better high temperature high pressure performance, better wellbore stability, less hydrates, better lubricity, etc., that traditional water based drilling fluids could not. One of the technical challenges in drilling operations with oil based drilling fluids, especially those performed on off-shore platforms, is the disposal of the oil based drill cuttings produced in an environmentally responsible manner.

Environmental regulations governing the disposal of oil based drilling cuttings have become restrictive. This is particularly challenging for drill cuttings containing as much as 17% oil by weight of oils from oil-formulated drilling fluids. The EPA defines the amount of oil in drill cuttings as the “Retention On Cuttings” (ROC), defined by (mass of oil)/(mass of Cuttings) and reported as a percentage. For offshore drilling, the EPA's Effluent Limitation Guidelines (2000) set the ROC of diesel based drilling fluid cuttings to 0%. For offshore drilling in the Gulf of Mexico, the “average” ROC for synthetic oil (linear or isomerized C16/C18 alpha-olefins and/or esters derived from vegetable oils) cuttings must be 6.9%. See Environmental Protection Agency, 2001, “Effluent Limitations Guidelines and New Source Performance Standards for the Oil and Gas Extraction Point Source,” Federal Register, 66, No. 14, Rules and Regulations, 40 CFR Parts 9 and 435.

U.S. Pat. Nos. 4,040,866, 4,836,302, 5,005,655, and 5,080,721 teach the use of organic solvents to remove oil based drilling fluids from the drilling cuttings. Although the technology provided quite satisfactory oil removal from the cuttings, there are significant safety concerns about volatility, toxicity and fire hazard during the operations. They were also were energetically expensive.

U.S. Pat. Nos. 5,156,686, 5,213,625, 5,215,596, 5,234,577 teach the use of fatty acid in mineral oils together with ether alcohol to remove oil based drilling fluid on the cuttings. U.S. Pat. No. 5,755,892 teaches the use of biodegradable O-functionalized fatty acid ester “Petrofree” wash oil to remove the oil from mineral oil based drilling cuttings. Although the disclosed methods used low volatile chemicals, the efficacy of the oil removal from the cuttings was a concern due to the lack of highly surface active materials in the compositions.

U.S. Pat. Nos. 4,139,462, 5,582,118 and U.S. 2005/0279715-A1 teach the treatments for oil based drilling cutting with heat to evaporate and incinerate the oil from the cuttings. Although this type of technology is still being practiced, it is energetically expensive, hazardous, and requires bulky equipment that is not convenient for off-shore drilling facilities.

US2204/0089321 teaches the use of supercritical fluids to remove the oil from the drilling cuttings. Similar approaches were discussed by Eldridge, et al., 1996, “Oil Contaminant Removal from Drill Cuttings by Supercritical Extraction,” Ind. Eng. Chem. Res., Vol. 35, Issue 6, pp. 1901-1905. But the large energy consumption, process versatility, cost and potential hazardous concerns remain a big issue.

U.S. Pat. Nos. 4,451,377, 5,090,498, 5,341,882, 5,454,957, and 6,267,893, along with Minton, R. C. et al., 1994, “Downhole injection of OBM cuttings economical in North Sea,” Oil & Gas J. Vol 92, Issue 22, pp. 75-79, disclose and discuss the removal of oil based drilling fluids from the drilling cuttings by various equipment approaches as well as the reinjection of cuttings into inactive wells.

More environmentally friendly and less energy intensive aqueous cleaning processes involving surfactants have also been investigated. U.S. Pat. No. 4,645,608 teaches the use of alcohol ethoxylates and phenol ethoxylates together with fatty alcohol solvent, and optional builder, to remove the oil from water based drilling cuttings; the detergent solution can also be recycled back into the water based drilling fluids.

U.S. Pat. No. 5,874,386 teaches the use of alkyl polyglycoside surfactant and alcohol ethoxylates in water to remove the oil based drilling fluids from a wellbore.

U.S. Pat. Nos. 5,634,984, 5,780,407, and 5,788,781 teach the use of nonionic surfactants, such as sorbitan tristearate and/or sorbitan monooleate, in a diluent oil, such as d-limonene, to treat mineral oil based drilling cuttings with subsequent rinsing of the treated cuttings with water by vigorous spraying. Although the disclosed cleaning results on cuttings were acceptable, the disclosed cleaner contains no water and no disclosures were made for further treatment of the generated cleaning water solution containing oil, surfactants, and fine solid particulates, etc. from the process.

U.S. Pat. Nos. 6,593,279 and 6,984,610 teach the use of acid based microemulsions to clean the oil based drilling fluids from the wellbore. The acids were emulsified in water with an anionic surfactant, a nonionic surfactant, a solvent, a co-solvent, etc.

The prior art does not disclose the cleaning of oil contaminated solid particulates with sea water.

### SUMMARY OF THE INVENTION

The present invention generally relates to a process for the cleaning oil contaminants from solid particulates. The invention also relates to a process and a surfactant composition for cleaning oil contaminated solids, such as cuttings, from oil and gas well drilling operations, and the separation and recovery of the oil from solid particulates.

### DETAILED DESCRIPTION OF THE FIGURES

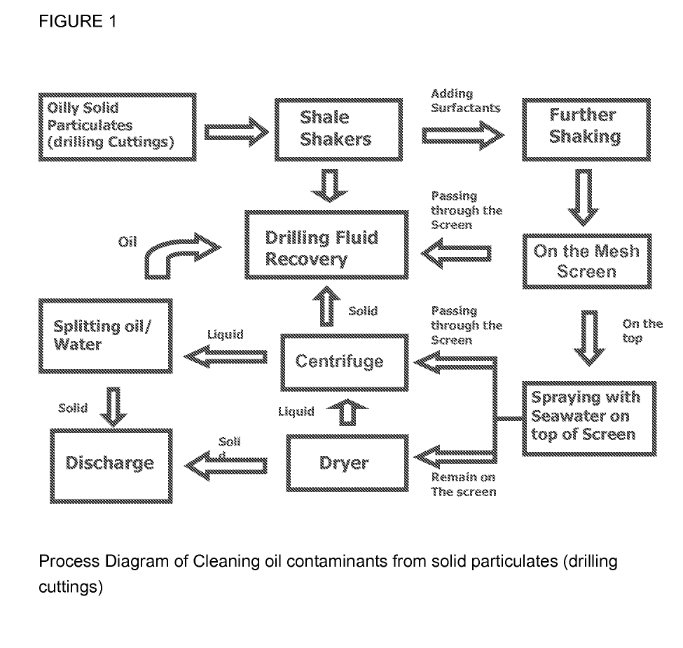

FIG. 1 is a process diagram of the cleaning process of the invention.

### DETAILED DESCRIPTION OF THE INVENTION

One embodiment of the cleaning process of the invention is illustrated in FIG. 1. After drilling cuttings are removed from the well by the oil based drilling fluid, the oil contaminated solid particulates are preferably treated with shaking/mixing-adding surfactants-spraying water on mesh screen-drying-centrifuging-splitting-recycling/discharging process of the invention.

In the process of the invention, the drilling fluid can be partially recovered from the shale shaker, and the remaining wet cutting stream, containing small pieces of rock, clay, shale, and sand with residual drilling fluid, further mixed with the surfactant based cleaning composition of the present invention by the shaker before being transferred to the mesh screen.

The solid particulates and/or drilling cuttings cleaner of the present invention comprises a combination of at least one degreaser with cloud point of less than cleaning temperature and one reversible hydrotrope that both are preferably “green” for environmental compatibility.

The degreasers of present invention include, but are not limited to alcohol ethoxylates/propoxylates, alkylphenol ethoxylates, EO/PO block copolymers, alkyl polyglycoside, alkyl carboxylates, alkyl ether carboxylates, alkyl sulfates, alkylether sulfates, linear alkylate sulfonate, alphaolefinsulfonate, methyl ester sulfonate, amine ethoxlyates, quaternary ammonium salts, amine oxides, amphoteric surfactants, organophosphates, etc. In one embodiment, the degreasers are alcohol ethoxylates/propoxylates having a narrow range distribution of the ethoxylates. Examples of suitable alcohol ethoxylates/propoxylates include, but are not limited to ethoxylated or propoxylated primary linear C₄ to C₂₀₊ alcohols.

The alcohol ethoxylate/propoxylate employable in the context of the present invention is represented by general formula I:

CH₃(CH₂)ₓ(C₂H₄O)ₘ(C₃H₆O)ₙOH I

wherein x is 1-20, in another embodiment 5-15;
m is 1-50, in another embodiment 3-10; and
n=is 0-10, in another embodiment 0-3.

Suitable alcohol ethoxylates for use in the present invention include, but are not limited to linear or branched heptyl alcohol ethoxylates, octyl alcohol ethoxylates, nonyl alcohol ethoxylates, decyl alcohol ethoxylates, undecyl alcohol ethoxylates, dodecyl alcohol ethoxylates, tridecyl alcohol ethoxylates, tetradecyl alcohol ethoxylates, mixtures thereof, and the like.

In another embodiment, suitable alcohol ethoxylates for use in the present invention include, but are not limited to, linear or branched octyl alcohol ethoxylates, nonyl alcohol ethoxylates, decyl alcohol ethoxylates, undecyl alcohol ethoxylates, docyl alcohol ethoxylates, tridecyl alcohol ethoxylates, mixtures thereof, and the like.

The reversible hydrotropes of present invention include, but are not limited to alcohol ethoxylates, alkylphenol ethoxylates, EO/PO block copolymers, alkyl polyglycoside, alkyl carboxylates, alkyl ether carboxylates, alkyl sulfates, alkylether sulfates, alkylate sulfonate, alphaolefinsulfonate, methyl ester sulfonate, amine ethoxlyates, quaternary ammonium salts, amine oxides, amphoteric surfactants, organophosphates, and any cleavable surfactants, etc. In one embodiment, the reversible hydrotropes are alkyl ether citrate and/or alkyl ether carboxylic acid with pKa of anywhere between 1 to 7, in another embodiment between 3 to 6, and having cloud points below the cleaning temperature when they are in the acid form.

The alkyl ether citrate employable in the context of the present invention is of the general formulae II, III and/or IV:

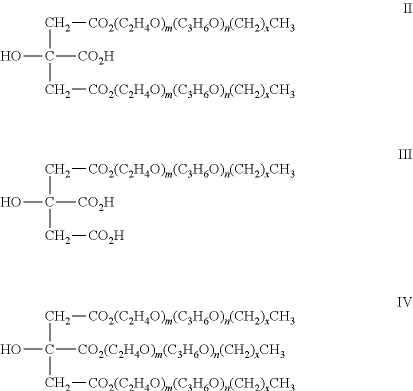

wherein x is 1-20, in another embodiment 5-15;
m is 1-50, in another embodiment 3-10; and
n is 0-10, in another embodiment 0-2.

Typically, alkyl ether citrates suitable for use in the present invention are mixture of II, III, and IV, where II is 0 to 100 mole %, in another embodiment 30-80 mole %; III is 0 to 50 mole %, in another embodiment 5 to 20 mole %; and IV is 0 to 50 mole %, in another embodiment 5 to 20 mole %.

Alkyl ether citrates suitable for use in the present invention include, but are not limited to, heptylether citrate ethoxylates, octylether citrate ethoxylates, nonylether citrate ethoxylates, decylether citrate ethoxylates, undecylether citrate ethoxylates, dodecylether citrate ethoxylates, tridecylether citrate ethoxylates, tetradecylether citrate ethoxylates, mixtures thereof, and the like.

In another embodiment, the alkyl ether citrate is octylether citrate ethoxylates, nonylether citrate ethoxylates, decylether citrate ethoxylates, undecylether citrate ethoxylates, dodecylether citrate ethoxylates, tridecylether citrate ethoxylates, or a mixture thereof.

The alkyl ether carboxylic acid employable in the context of the present invention is of the general formulae V:

CH₃(CH₂)ₓ(C₂H₄O)ₘ(C₃H₆O)ₙCH₂C(O)OH V

wherein x is 1-20, in another embodiment 5-15;
m is 1-50, in another embodiment 3-10; and
n is 0-10, in another embodiment 0-2.

Alkyl ether carboxylic acid suitable for use in the present invention include, but are not limited to, heptylether carboxylic acid ethoxylates, octylether carboxylic acid ethoxylates, nonylether carboxylic acid ethoxylates, decylether carboxylic acid ethoxylates, undecylether carboxylic acid ethoxylates, dodecylether carboxylic acid ethoxylates, tridecylether carboxylic acid ethoxylates, tetradecylether carboxylic acid ethoxylates, mixtures thereof, and the like.

In another embodiment, the alkyl ether carboxylic acid is octylether carboxylic acid ethoxylates, nonylether carboxylic acid ethoxylates, decylether carboxylic acid ethoxylates, undecylether carboxylic acid ethoxylates, dodecylether carboxylic acid ethoxylates, tridecylether carboxylic acid ethoxylates, or a mixture thereof.

The weight ratio of degreaser to hydrotrope is generally in the range of from about 0.01-100. In another embodiment said ratio is in the range of from about 0.5-25, and in still another embodiment from about 0.5-5. The weight ratio of solid particulates to surfactants is generally in the range of from about 0.1-1000. In another embodiment said ratio is in the range of from about 5-100, and in still another embodiment from about 5-50.

The present invention relates to both an aqueous and a non-aqueous cleaner system for cleaning the solid particulates and/or drillings cuttings. The aqueous system is preferred for obvious environmental reasons. Also, a no-aqueous system containing the base oils (diesel or mineral or polyolefin) of the oil based drilling fluid is preferred as the oil can be recycled back to the drilling fluids after the cleaning. Typically, anywhere between about 0.1 to 80 wt % of the surfactants of the invention are employed in cleaner system, in another embodiment, between about 5 to 50 wt % are employed.

The interaction between cleaner and solid particulates is required in order to remove the oil from the solids with mixing and agitation. The mixing time is anywhere from 10 seconds to 0.5 to 2 hours, in another embodiment, from 1 min to 30 min. The temperature of mixing is anywhere from 1° C. to 90° C., in another embodiment, ambient temperature. Typical mixing equipments can be used for the cleaning; however, the shale shakers are preferred for the oil based drilling cuttings cleaning.

After mixing the solid particulates and the cleaner formulation of the invention, the wet mixture is separated by screening. The screen size is anywhere between 10 μm to 500 μm, in another embodiment, between 50 μm to 100 μm. The liquid of oil/cleaner mixture together with fine solid particulates are separated by gravity from the remaining larger solid particulates on top of the screen.

The water, preferable seawater on offshore platform for economical purpose, is sprayed on the remaining solid particulates on top of the screen. The weight ratio of water (seawater) to solid particulates is generally in the range of from about 0.1-100. In another embodiment said ratio is in the range of from about 0.5-50, and in still another embodiment from about 0.5-10. The liquid of oil/cleaner/water mixture together with fine solid particulates are separated by gravity from the remaining larger solid particulates on top of the screen.

The residual solid particulates on top of the screen are dried and awaited for residual oil content measurement and discharge. The drying temperature is anywhere at or above ambient temperature. The drying time is anywhere between 1 min to 10 hrs until the water is fully evaporated. Longer drying time is not desirable. Sometimes, no drying is needed for the cleaned solid particulates to be discharged by the invention.

The reversible hydrotroping mechanism is applied where the recovery of oils and surfactants is needed. The cleaning solution generally contains oils, surfactants (degreasers and hydrotropes), fine solid particulates, and water (sea water), etc. The oil/water phase separation (splitting) occurs when hydrotrope is eliminated or not in function. The splitting is generally accelerated with heating.

Typical oil/water splitting is accomplished when (1) the hydrotrope is a cationic surfactant where the surfactant tends to adsorb on the anionic surface of clay based solid particulates thereby eliminating the hydrotroping function; (2) the hydrotrope is an anionic surfactant where it's hydrotroping function is reversed after it is protonated; (3) the hydrotrope is a cleavable surfactant where its hydrotroping function is destroyed after it's structure is cleaved.

The liquid of cleaning waste generated from the present invention after water (sea water) spraying, screening, and splitting process is preferably decanting centrifuged where the top layer of oils and bottom layer of fine solid particulates are recovered and recycled. The middle layer of clean water (sea water) is discharged or reused.

The invention will now be exemplified by the following non-limiting examples.

### Example 1

### Preparation of Alkylether Citrate

One mole of citric acid was slowly added to two mole of alcohol ethoxylate (C₁₀EOₓ) along with 0.5% of sulfuric acid as a catalyst. The temperature was raised from an initial reading of 30° C. to about 100° C. during the addition. After the addition of citric acid, the temperature was raised to the final reaction temperature of 140° C. The progress of the reaction was followed by analyzing for acid number. The reaction was considered complete when an acid number equivalent to about one third of the initial citric acid acidity was achieved. After cooling the alkylether citrate to about 30° C., NaOH (50%) was added until a pH of 6.5-7.5 was reached. The final product was diluted with water to 40% active.

### Example 2

### Carboxylation of Berol 260

1.6 mole of Sodium Monochloroacetate (SCMA) was charged to 1 mole of dehydrated Berol 260 (C₉₋₁₁(EO)₄) at 55° C. while stirring. Then, the 1.6 mole of caustic soda beads were charged over a period of 8 hours. The temperature was maintained in a range from 53 to 65° C. during the entire caustic addition. With the caustic addition complete, the flask contents were digested for two hours at 65° C., then at 90° C. for one hour. The final product was about 95% active. The acid form was prepared by adding dilute sulfuric acid.

### Example 3

### Typical Laboratory Cleaning Process for the Oil Contaminated Solid Particulates

70 g of non aqueous drilling fluid (NADF) cuttings (containing olefin based drilling fluids from Exxon Mobil) was mixed with 4 g of Berol 260 (nonionic surfactant from Akzo Nobel) and 3 g of sample from Ex.1 or Ex.2 and 26 g of drilling fluid base oil (alpha olefin isomer). After mixing for 15 min with Eberbach lab shaker (model 6000), the mixture was poured on the USA standard testing sieve with mesh size equivalent to 200 mesh (Fisher Scientific #200). The liquid slurry was drained through the mesh by gravity, separated from the cuttings, and collected for recycle. The residual cuttings on the top of the screen sieve were sprayed with 300 g of artificial seawater (ASTM D-1141-52), and dried at 60° C. for API retort test. The pH of the liquid (containing oil, surfactants, fine solid particulates, and seawater) was adjusted to 4, and then the liquid was centrifuged with IEC lab centrifuge (Centra GP8R) at 1500 rpm for 15 min. Then the mixture was heated to 65° C. for about 30 min and three distinct layers formed in the mixture where the top layer of oil and bottom layer of fine solid particulates were recycled. The middle layer of clean seawater was discharged or reused for the spray.

The retort test for the cuttings was conducted according to the American Petroleum Institute (API) Recommended Practice For Field Testing of Oil-Based Drilling Fluid 13B-2, Annex B (p. 47-50).

“Retention on Cuttings” (ROC) is defined by (mass of oil)/(mass of cuttings) in percentage was measured by the retort test.

### Example 4

TABLE 1
Description of NADF drilling cuttings from Exxon Mobil

| Sample | Description | ROC (%) |
|---|---|---|
| #3 | Wet cuttings from shaker feed | 10.3 |
| | to dryer (cuttings dryer | |
| | feedstock) | |
| #7 | Decanting centrifuge cake | 10.14 |

### Example 5

The #3 NADF drilling cuttings were treated with the typical cleaning formulation in Ex.3 with hydrotrope prepared from Ex. 1 with different alkylether citrates (C₁₀EOₓ) and different moles of EO content (X). The ROC of the cuttings after washing is illustrated in the following graph.

ROC (%) of #3 NADF cuttings vs. the EO content of alkylether citrate

### Example 6-9

The #7 NADF drilling cuttings decanting centrifuge cake were treated with the typical cleaning formulation in Ex.3 with hydrotrope prepared from Ex. 2. The ROC of the cake after washing was listed in Table 2.

TABLE 2
ROC of decanting centrifuge cake after washing

| | Ex. 6 | Ex. 7 | Ex. 8 | Ex. 9 |
|---|---|---|---|---|
| #7 Decanting cake (g) | 70 | 70 | 70 | 90 |
| Berol 260 (g) | 4 | 4 | 4 | 2 |
| Ex. 2 (g) | 2 | 2.6 | 1.3 | 3 |
| Water (g) | — | 5.4 | 2.7 | — |
| Alpha olefin isomer (g) | 26 | 26 | 26 | 26 |
| Seawater (g) | 215 | 200 | 200 | 275 |
| ROC (%) | 1.95 | 1.6 | 1.4 | 4.6 |

### Example 10

The #3 NADF drilling cuttings were treated with the typical cleaning formulation in Ex.3 with hydrotrope prepared from Ex. 1, but without drying. The ROC of the wet cuttings was 3.6%.

### Example 11-14

The #3 NADF drilling cuttings were treated with the typical cleaning process in Ex.3 with hydrotrope prepared from Ex. 1, except replacing Berol 260 with Berol 533 (C₉₋₁₁(EO)₃ from Akzo Nobel). The ROC of the cuttings after washing was listed in Table 3.

TABLE 3
ROC of drilling cuttings after washing

| | Ex. 11 | Ex. 12 | Ex. 13 | Ex. 14 |
|---|---|---|---|---|
| #3 Drill cuttings (g) | 70 | 70 | 70 | 90 |
| Berol 533 (g) | 4 | 1 | 2 | 2 |
| Ex. 1 (5.5 mol EO) (g) | 1.2 | 1.2 | — | — |
| Ex. 1 (5 mol EO) (g) | — | — | 0.8 | — |
| Ex. 1 (4.5 mol EO) (g) | — | — | — | 0.8 |
| Water (g) | 1.8 | 1.8 | 1.2 | 1.2 |
| Alpha olefin isomer (g) | 26 | 26 | 26 | 26 |
| Seawater (g) | 300 | 300 | 300 | 300 |
| ROC (%) | 2.1 | 2.2 | 3.36 | 2.4 |

### Example 15

The #3 NADF drilling cuttings which were premixed with Exxon Mobil's NADF to have ROC of 20%) were treated with the typical cleaning process in Ex.3 with hydrotrope prepared from Ex. 1. After cleaning, the ROC of the cuttings was 3%.

1. A method for cleaning oil contaminants from solids which comprises contacting said oil contaminated solids with a cleaning composition for a time and at a temperature effective to clean said solids, wherein said cleaning composition comprises at least one degreaser with a cloud point of less than the cleaning temperature, and at least one reversible hydrotrope.

2. The method according to claim 1 wherein said solids are contacted with said cleaning composition for 10 seconds up to 2 hours at a cleaning temperature of from −12° C. (10° F.) to about +82° C. (180° F.).

3. The method according to claim 1 wherein said degreaser is chosen from the group consisting of alcohol ethoxylates/propoxylates, alkylphenol ethoxylates, EO/PO block copolymers, alkyl polyglycoside, alkyl carboxylates, alkyl ether carboxylates, alkyl sulfates, alkylether sulfates, alkylate sulfonate, alpha olefinsulfonate, methyl ester sulfonate, amine ethoxlyates, quaternary ammonium salts, amine oxides, amphoteric surfactants, organophosphates or combinations or mixtures thereof.

4. The method according to claim 1 wherein said at least one reversible hydrotrope is chosen from the group consisting of alcohol ethoxylates, alkylphenol ethoxylates, EO/PO block copolymers, alkyl polyglycoside, alkyl carboxylates, alkyl ether carboxylates, alkyl sulfates, alkylether sulfates, alkylate sulfonate, alpha olefinsulfonate, methyl ester sulfonate, amine ethoxlyates, quaternary ammonium salts, amine oxides, amphoteric surfactants, organophosphates, cleavable surfactants, or combinations or mixtures thereof.

5. The method according to claim 1, wherein said at least one degreaser is chosen from alcohol ethoxylate/propoxylates represented by general formula I,
CH₃(CH₂)ₓ(C₂H₄O)ₘ(C₃H₆O)ₙOH I
wherein x is 1-20; m is 1-50; and n=is 0-10;
and wherein said at least one reversible hydrotrope is an alkyl ether citrate and/or alkyl ether carboxylic acid with a pKa of from 1 to 7.

6. The method according to claim 5, wherein said alkyl ether citrate is of the general formulae II, Ill and/or IV: 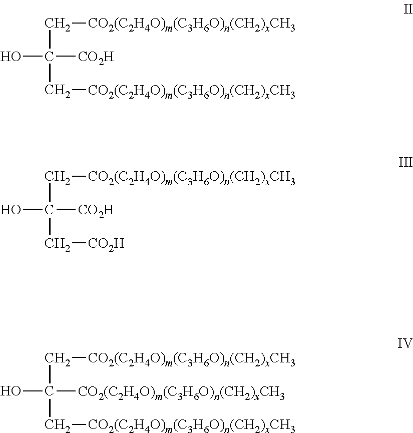
wherein x is 1-20; m is 1-50; and n is 0-10.

7. The method according to claim 5, wherein said alkyl ether citrate is chosen from the group consisting of heptylether citrate ethoxylates, octylether citrate ethoxylates, nonylether citrate ethoxylates, decylether citrate ethoxylates, undecylether citrate ethoxylates, dodecylether citrate ethoxylates, tridecylether citrate ethoxylates, tetradecylether citrate ethoxylates, or combinations or mixtures thereof.

8. A composition which comprises (i) at least one compound chosen from the group consisting of alcohol ethoxylates/propoxylates, alkylphenol ethoxylates, EO/PO block copolymers, alkyl polyglycoside, alkyl carboxylates, alkyl ether carboxylates, alkyl sulfates, alkylether sulfates, alkylate sulfonate, alpha olefinsulfonate, methyl ester sulfonate, amine ethoxlyates, quaternary ammonium salts, amine oxides, amphoteric surfactants, organophosphates or combinations or mixtures thereof, and (ii) at least one compound chosen from the group consisting of alkyl ether citrates and alkyl ether carboxylic acids with a pKa of from 1 to 7.

9. A process for cleaning drill cutting solids contaminated with oil which comprises, in an initial cleaning zone, (i) feeding said oil-contaminated drill cutting solids and a cleaning composition to a slurrying stage where the cleaning composition contacts the solids thereby dissolving the oil contaminant and forms a slurry, (ii) withdrawing the slurry from the slurrying stage and introducing the slurry to a mesh screen and optionally spraying water, or a base oil of said particulates on said mesh screen, followed by introducing said washed particulates/cleaning composition to a centrifuging stage where the slurry is centrifuged to further separate the solids having reduced oil-contamination from the cleaning composition containing dissolved oil contaminant, and (iii) discharging and recovering the solids having reduced oil-contamination from the centrifuging stage of the cleaning zone; said process being further characterized in that the discharge of cleaning composition containing dissolved oil contaminant is recovered for recycling, wherein said cleaning composition comprises at least one degreaser with a cloud point of less than the cleaning temperature, and at least one reversible hydrotrope.
